(19) United States
(12) Patent Application Publication
(10) Pub. No.: US 2024/0023615 A1
(43) Pub. Date: Jan. 25, 2024

(54) HEATING MECHANISM FOR HEATING IN STAGES, AND ATOMIZATION APPARATUS USING SAME

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/026,598

(22) PCT Filed: Jun. 30, 2021
(86) PCT No.: PCT/CN2021/103815

§ 371 Date: Mar. 16, 2023

(51) Int. Cl. A24F 40/46; A24F 40/48; A24F 40/10

(52) U.S. Cl. CPC A24F 40/46; A24F 40/48; A24F 40/10

(57) ABSTRACT

Disclosed is a heating mechanism for healing in stages, which comprises a heating circuit and electrodes; the heating circuit comprises a pre-heating portion buried within a liquid guide body, and an atomization portion fit on or inlaid in an atomization surface of the liquid guide body; the pre-heating portion and the atomization portion are connected in series and/or connected in parallel between electrodes the pre-heating portion and the atomization portion are stacked, causing projections thereof to completely or partially overlap; or the pre-heating portion and the atomization portion are arranged at high and low levels, causing projections thereof to not overlap; and at least the atomization portion is a complete structure, and the shape and size thereof match uniformly with the atomization surface of the liquid guide body.

### FIELD

The invention belongs to the technical field of atomization, and relates to a heating mechanism configured for heating in stages and an atomization device comprising the same.

### BACKGROUND

Electric heating atomization, as a novel atomization technique emerging in recent years, generates heat based on the heat effect of resistors and then heats and atomizes liquid into steam by means of the heat, and has been widely applied to medical treatment, smart household appliances and consumer electronic products. Existing atomization devices used in the e-cigarette industry typically transfer liquid through a liquid transfer medium and heat e-liquid by heat, which is generated by a heating unit in a power-on state, until the e-liquid is evaporated and atomized. In order to prevent e-liquid from leaking from an atomizer, the amount of liquid heated and atomized on an atomization surface of the heating unit should be small, so liquid needs to pass through a porous medium to reach the atomization surface. During the heating atomization process, the viscosity of e-liquid will change with the working time: in the initial state, the e-liquid is at room temperature, so the kinematic viscosity of the e-liquid is high; when the temperature of the heating unit is transferred to the liquid transfer body and the e-liquid during the heating atomization process, the kinematic viscosity of the e-liquid will decrease with the rise of the temperature, which has an influence on the flow rate of the e-liquid in the porous liquid transfer body; and particularly, for e-liquid with a high kinematic viscosity at normal temperature, the flow rate of the e-liquid will change drastically after the e-liquid is heated to high temperature, so the problem of a small quantity of smoke, inadequate e-liquid supply or core burning will be caused at the beginning of the atomization process, leading to poor user experience.

To solve this problem, a technical improvement made in the prior art to improve the liquidity of e-liquid with poor liquidity is to enlarge the micro-pores of the liquid transfer medium, so as to reduce or avoid the problem of core burning caused by inadequate e-liquid supply. However, after the micro-pores are enlarged, the temperature of the heating unit is transferred to e-liquid with the increase of the working time, which in turn increases the temperature of the e-liquid, decreases the viscosity of the e-liquid and improves the fluidity of the e-liquid, so liquid leaking occurs easily.

For e-liquid with a high kinematic viscosity, another method proposed to prevent core burning is to reduce liquid consumption by reducing heat; however, the reduction of heat will lead to a small amount of smoke and insufficient atomization, so user experience is unsatisfying.

### SUMMARY

The technical issue that the invention aims to resolve is to provide, in view of the drawback of the prior art, a heating mechanism for heating in stages which can reduce or avoid the issue of small smoke amount at the beginning of working and achieve uniform atomization effect without enlarging micropores or reducing heat, and an atomization device.

The technical solution adopted by the present invention to solve the technical issue is as following:
a heating mechanism configured for heating in stages, comprises a heating circuit configured for evaporating liquid, and electrodes configured to be connected to a power supply unit, wherein the heating circuit comprises a preheating part buried in a liquid transfer body, and an atomization part attached to or inlaid in an atomization surface of the liquid transfer body;
the preheating part and the atomization part are connected in series and/or in parallel between the electrodes;
the preheating part and the atomization part are stacked, such that projections of the preheating part and the atomization part overlap entirely or partially; or, the preheating part and the atomization part are arranged in a ladder type, such that the projections of the preheating part and the atomization part do not overlap;
at least the atomization part is an integral structure, and is matched and identical with the atomization surface of the liquid transfer body in shape and size.

Further, in the heating mechanism configured for heating in stages the electrodes, preferably, the preheating part and the atomization part are formed integrally to form an integral structure.

Further, in the heating mechanism configured for heating in stages the electrodes, preferably, the electrodes comprise a preheating electrode, an atomization electrode and a common electrode, the atomization part is connected between the atomization electrode and the common electrode through electrode contacts, and the preheating part is connected between the preheating electrode and the common electrode through electrode contacts.

Further, in the heating mechanism configured for heating in stages, preferably, the electrodes comprise two preheating electrodes and two atomization electrodes, the atomization part is connected between the two atomization electrodes through electrode contacts, and the preheating part is connected between the two preheating electrodes through electrode contacts.

Further, in the heating mechanism configured for heating in stages, preferably, the electrodes comprise two common electrodes, and the atomization part and the preheating part are connected in series and/or in parallel between the two common electrodes through electrode contacts.

Further, in the heating mechanism configured for heating in stages, preferably, the atomization part and the preheating part are each an integral structure, and the atomization part and the preheating part are stacked or arranged in a ladder type.

Further, in the heating mechanism configured for heating in stages, preferably, the atomization part is an integral structure, and the preheating part is formed by multiple separate structures connected to the atomization part, and the atomization part and the preheating part are stacked or arranged in a ladder type.

Further, in the heating mechanism configured for heating in stages, preferably, the preheating part and the atomization part are each a planar structure, a curved structure, or a combination of at least one of the planar structure and the curved structure.

Further, in the heating mechanism configured for heating in stages, preferably, the preheating part and the atomization part are each a planar structure or a combination of said planar structures, and are arranged in parallel; or, the preheating part and the atomization part are each a planar structure or a combination of said planar structures, an angle α is formed between the preheating part and the atomization part, and 90°≥α>0°.

Further, in the heating mechanism configured for heating in stages, preferably, the atomization part is a planar structure or a combination of said planar structures, and the preheating part is a curved structure or a combination of said curved structures.

Further, in the heating mechanism configured for heating in stages, preferably, the atomization part is a curved structure and a combination of said curved structures, and the preheating part is one of a curved structure, a combination of said curved structures, a planar structure or a combination of said planar structures.

Further, in the heating mechanism configured for heating in stages, preferably, the preheating part and the atomization part are connected into an integral structure through electrode contacts or through a transition part.

Further, in the heating mechanism configured for heating in stages, preferably, a diameter or width of the atomization part is constant or basically constant; or, the diameter or width of the atomization part increases or decreases gradually or is regular with respect to a center of the heating mechanism.

Further, in the heating mechanism configured for heating in stages, preferably, a distance between different positions of the atomization part is constant from one end to the other end, or decreases gradually from a middle to two ends of the atomization part, or increases gradually form the middle to the two ends of the atomization part.

Further, in the heating mechanism configured for heating in stages, preferably, the atomization part is connected to a fixing part configured for fixedly attaching the atomization part to the atomization surface of the liquid transfer body.

Further, in the heating mechanism configured for heating in stages, preferably, at least one said fixing part is arranged and is disposed at least on an edge of the atomization part.

An atomization device comprises a liquid transfer body, and the heating mechanism described above. The heating mechanism is inlaid in or attached to a surface of the liquid transfer body.

The invention has the following beneficial effects:

The heating circuit of the invention is provided with a preheating part and an atomization part, wherein the preheating part is buried in a liquid transfer body. First, the preheating part buried in the liquid transfer body preheats the liquid transfer body and e-liquid in the liquid transfer body, so as to reduce the kinematic viscosity of the e-liquid in the liquid transfer body and improve the fluidity of the e-liquid, such that the e-liquid can quickly reach an atomization surface from a liquid inlet side of the liquid transfer body, and the heating mechanism can adapt to e-liquid with a high viscosity without enlarging micro-pores of the liquid transfer body or reducing the amount of smoke by reducing the heat of a heating unit.

### BRIEF DESCRIPTION OF THE DRAWINGS

The invention will be further described below in conjunction with accompanying drawings and embodiments. In the drawings:

FIG. 1 and FIG. 2 are structural diagrams of Embodiment 1-1 of the invention;

FIG. 3 is a structural diagram of the positional relationship between a preheating part and an atomization part according to Embodiment 1-2 of the invention;

FIG. 4 is a structural diagram of the positional relationship between a preheating part and an atomization part according to Embodiment 1-3 of the invention;

FIG. 5 is a structural diagram of the positional relationship between a preheating part and an atomization part according to Embodiment 1-4 of the invention;

FIG. 6 is a structural diagram of the positional relationship between a preheating part and an atomization part according to Embodiment 1-5 of the invention;

FIG. 7 is a structural diagram of the positional relationship between a preheating part and an atomization part according to Embodiment 1-6 of the invention;

FIG. 8 is a structural diagram of Embodiment 1-7 of the invention;

FIG. 9-FIG. 11 is a structural diagram of Embodiment 2-1 of the invention;

FIG. 12 is a structural diagram of Embodiment 2-2 of the invention;

FIG. 13-FIG. 17 are structural diagrams of Embodiment 2-3 of the invention;

FIG. 14-FIG. 18 are structural diagrams of Embodiment 2-4 of the invention.

### DESCRIPTION OF THE EMBODIMENTS

For the sake of a better understanding of the technical features, purposes and effects of the invention, the specific implementations of the invention will be described in detail with reference to the accompanying drawings.

When one element is referred to as being “fixed on” or “disposed on” the other element, it may be located on the other element directly or indirectly. When one element is referred to as being “connected to” the other element, it may be connected to the other element directly or indirectly.

Terms such as “upper”, “lower”, “left”, “right”, “front”, “back”, “vertical”, “horizontal”, “top”, “bottom”, “inner” and “outer” are used to indicate directional or positional relations based on the accompanying drawings merely for the purpose of facilitating the description, and should not be construed as limitations of the technical solution of the invention. Terms such as “first” and “second” are merely configured for a descriptive purpose, and should not be construed as indicating or implying relative importance or implicitly indicating the number of technical features. Unless otherwise expressly defined, “multiple” means two or more.

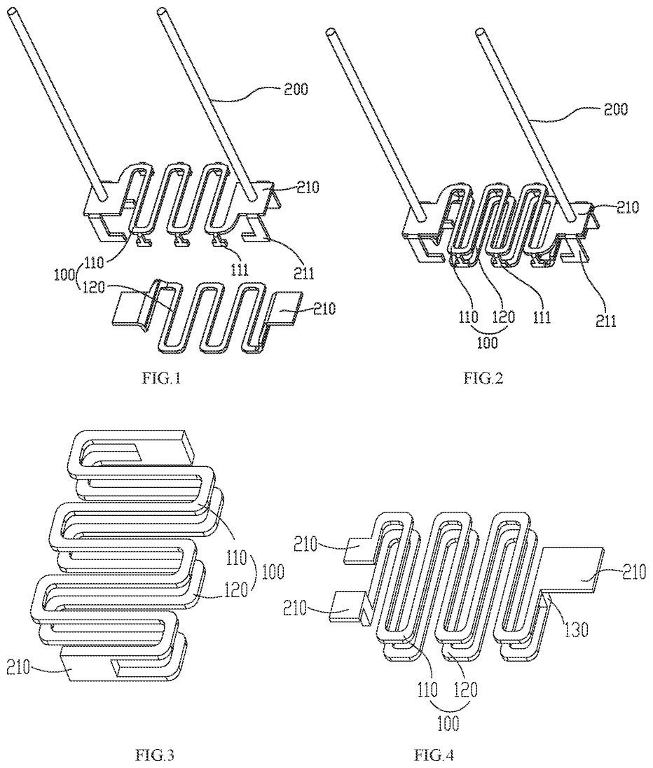

Embodiment 1: As shown in FIG. 1-FIG. 8, a heating mechanism configured for heating in stages comprises a heating circuit 100 configured for evaporating liquid, and electrodes 200. The heating circuit 100 comprises a preheating part 120 buried in a liquid transfer body, and an atomization part 110 attached to or inlaid in an atomization surface of the liquid transfer body; the preheating part 120 and the atomization part 110 are connected in series or/and in parallel between the electrodes 200; the preheating part 120 and the atomization part 110 are stacked, such that projections of the preheating part 120 and the atomization part 110 overlap entirely or partially, or, the preheating part 120 and the atomization part 110 are arranged in a ladder type, such that the projections of the preheating part 120 and the atomization part 110 do not overlap; and at least the atomization part 110 is an integral structure, and is matched and identical with the atomization surface of the liquid transfer body in shape and size.

In actual application, the viscosity of e-liquid changes with temperature: in the initial state, the e-liquid is at room temperature which is low, the kinematic viscosity of the e-liquid is high, the flow rate of the e-liquid in the porous liquid transfer body is low, and a small amount of e-liquid reaches a heating element, so the amount of smoke is small at the beginning of work, which is reflected by inadequate liquid supply, and core burning occurs easily. After a period of time, the temperature of the porous liquid transfer body rises gradually during the atomization process, the flow rate of the e-liquid in the porous liquid transfer body increases gradually, the quantity of e-liquid reaching the heating element is increased, and the quantity of smoke is increased accordingly.

The most direct purpose of the invention is to realize uniform atomization of e-liquid in different time periods from beginning to end, so as to solve the problem of a small quantity of smoke at the beginning of work. Based on the prior art in which only the heating circuit 100 disposed on the atomization surface of the liquid transfer body, in the present invention, the heating circuit is extended, the atomization area remains unchanged, preheating is added, the atomization part 110 and the preheating part 120 are formed, the atomization part 110 is configured for atomizing e-liquid on the atomization surface, and the preheating part 120 is configured for increasing the temperature of the liquid transfer body, that is, the e-liquid is preheated before reaching the atomization surface, such that the kinematic viscosity of the e-liquid is decreased, and uniform and sufficient atomization can be realized in different time periods of the atomization process.

According to the number of electrodes, the invention has three implementations:
First implementation: the electrodes comprise a preheating electrode, an atomization electrode and a common electrode, the atomization part is connected between the atomization electrode and the common electrode through electrode contacts, and the preheating part is connected between the preheating electrode and the common electrode through electrode contacts.
Second implementation: the electrodes comprise two preheating electrodes and two atomization electrodes, the atomization part is connected between the two atomization electrodes through electrode contacts, and the preheating part is connected between the two preheating electrodes through electrode contacts.
Third implementation: the electrodes comprise two common electrodes, and the atomization part and the preheating part are connected in series or/and in parallel between the two common electrodes through electrode contacts.

Wherein, in the first two implementations, the atomization part and the preheating part adopt different electrodes and can be powered on separately to realize heating respectively. Due to the fact that atomization and preheating require different temperatures and times and the preheating part does not need to operate continuously for a long time because the atomization part also has a heating effect on the liquid transfer body after atomization is performed for a period of time. The heating time of the atomization part and the heating time of the preheating part are controlled separately; the atomization part and the preheating part work at the same time in the first several seconds after atomization is started; or the preheating part works first to preheat the liquid transfer body and the e-liquid to reduce the kinematic viscosity of the e-liquid, and then the preheating part stops working and only the atomization part works to atomize the e-liquid. These two implementations not only can quickly preheat the e-liquid to reduce the kinematic viscosity of the e-liquid, but also can save energy and prevent liquid leaking caused by an excessively low kinematic viscosity of the e-liquid.

In the third implementation, two common electrodes are used, so control is convenient and easy.

In the invention, the main structure for heating is the atomization part 110, and the atomization part 110 is linear on the whole, and is bent and turned to form a planar structure, a combination of the planar structures, a curved structure, a combination of the curved structures, or the like. That is, the atomization part 110 is disposed on the atomization surface of the liquid transfer body, which is a plane, a curved surface or a combination of the plane and the curved surface, such that heating within the atomization surface is realized.

In the invention, at least the atomization part is an integral structure, and is matched and identical with the atomization surface of the liquid transfer body in shape and size. That is, the atomization part 110 in the invention is equivalent to the whole heating circuit in the prior art and may be of a shape and structure the same as those of various heating circuits in the prior art. The atomization part 110 is at least one of a linear unit and a curved unit, or a structure formed by end-to-end connection or crossing of the linear unit and the curved unit. The invention has no limitation to the structure of the atomization part 110 as long as the atomization part 110 is a relatively regular structure, which means that the width or local coverage of different positions of the atomization part 110 is basically the same. Preferably, the diameter or width of the atomization part 110 is constant or basically constant; or, due to the heat effect, the diameter or width of the atomization part 110 increases or decreases gradually or is regular with respect to the center of the heating mechanism. The center of the heating mechanism may be the geometry center point of the heating mechanism, or the longitudinal or horizontal central axis of the heating mechanism. The width or diameter of the atomization part 110 is designed as actually needed.

Specifically, the atomization part 110 may have different structures:
First implementation: the atomization part 110 is formed by one or multiple linear units, wherein one linear unit may be linearly arranged from one electrode contact 210 to the other electrode contact 210; and multiple linear units may be connected by end-to-end to form a linear, zigzag or circular atomization part 110.
Second implementation of the atomization part 110: the atomization part 110 is formed by one or multiple curved units. One curved unit may be arranged from one electrode contact 210 to the other electrode contact 210. Multiple curved units may be connected by end-to-end to form a wavy or circular atomization part 110.
Third implementation of the atomization part 110: the atomization part 110 is formed by end-to-end connection of one or more linear units and curved units, and the linear units and the curved unit are arranged separately or alternately.
Fourth implementation of the atomization part 110: the atomization part 110 is formed by crossing connection or staggered connection of multiple linear units, and “crossing connection” or “staggered connection” means that multiple linear units extend in multiple directions and are crossed or staggered in one extension direction. Wherein, “crossing” means that multiple linear units are connected directly.
Fifth implementation of the atomization part 110: the atomization part 110 is formed by crossing or staggered connection of multiple curved units. Wherein, “crossing” means that multiple curved units are connected directly.
Sixth implementation of the atomization part 110: the atomization part 110 is formed by crossing or staggered connection of at least one linear unit and at least one curved unit, which is a technical solution formed by combining the fourth implementation and the fifth implementation.

The other part of the heating circuit 100 is the preheating part 120, which is buried in the liquid transfer body and is configured for preheating e-liquid delivered onto the atomization surface of the liquid transfer body, to reduce the kinematic viscosity of the e-liquid and increase the flow rate of the e-liquid. The structure of the preheating part 120 is matched with the structure of the atomization part 110, and the preheating part 120 can be any structure to realize heating, that is, any structure powered on to heat can be formed, and the invention has no limitation in this aspect.

The preheating part 120 and the atomization part 110 are each a planar structure, a curved structure, or a combination of at least one of the planar structure and the curved structure. According to the shape of the atomization surface of the liquid transfer body, the atomization part 110 is attached to or inlaid in the atomization surface of the liquid transfer body, so the atomization part 110 is matched and identical with the atomization surface in shape.

The positional relationship between the preheating part 120 and the atomization part 110 is as follows:
First implementation: the preheating part 120 and the atomization part 110 are each a planar structure or a combination of the planar structures, and are arranged in parallel.
Second implementation: the preheating part 120 and the atomization part 110 are each a planar structure or a combination of the planar structures, an angle α is formed between the preheating part 120 and the atomization part 110, and 90°≥α>0°.

In the above two implementations, the preheating part is bent based on the atomization part, and the preheating part and the atomization part are parallel, or an angle α is formed between the preheating part and the atomization part. Here, “parallel” may means that the preheating part and the atomization part are attached to each other, or the preheating part and the atomization part are spaced apart from each other, which is realized through a transition part.
Third implementation: the atomization part 110 is a planar structure or a combination of the planar structures, and the preheating part 120 is a curved structure or a combination of the curved structures. In this implementation, the preheating part may be attached to the atomization part, which means that at least two points of the preheating part are attached to the atomization part. Or, the preheating part may be spaced apart from the atomization part, which means that the preheating part is not entirely attached to the atomization part, for example, the preheating part is completely spaced apart from the atomization part; or, one end of the preheating part is fixedly connected to one end of the atomization part or the preheating part is integrated with the atomization part, and only the middle portions or/and the other ends of the preheating part and the atomization part are spaced apart from each other.
Fourth implementation; the atomization part 110 is a curved structure and a combination of the curved structures, and the preheating part 120 is a curved structure and a combination of the curved structures, or a planar structure, or a combination of the planar structures. Similarly, the preheating part may be attached to the atomization part or may be spaced apart from the atomization part, as mentioned above.

The atomization part 110 and the preheating part 120 are connected in series and/or in parallel. The atomization part 110 and the preheating part 120 may be connected in series between the two electrode contacts 210, connected in parallel between two electrode contacts 210, or connected both in series and in parallel between two electrode contacts 210. One or more atomization parts 110 and one or more preheating part 120 may be arranged. Specifically:
First implementation: the atomization part 110 and the preheating part 120 are connected in parallel, two ends of the atomization part 110 are respectively connected to the electrode contacts 210, and two ends of the preheating part 120 are also respectively connected to the electrode contacts 210.
Second implementation: the atomization part 110 and the preheating part 120 are connected in parallel locally, that is, two ends of the atomization part 110 are respectively connected to the electrode contacts 210, and the preheating part 120 is connected in parallel with at least one section of the atomization part 110.
Third implementation: the atomization part 110 and the preheating part 120 are connected in series, and the two are connected together, and only one end of the atomization part 110 and only one end of the preheating part 120 are connected to the electrode contacts 210.

In case of multiple atomization parts 110, the multiple atomization parts 110 are arranged in parallel, and two ends of the multiple atomization parts 110 are joined together and then are connected to the electrode contacts 210.

In case of multiple preheating parts 120, the multiple preheating parts 120 are arranged separately and are connected to the atomization part 110 in parallel or in series.

The invention has no limitation to the connection relation between the preheating part 120 and the atomization part 110. The preheating part 120 and the atomization part 110 may be connected fixedly or formed integrally. Preferably, the preheating part 120 and the atomization part 110 are formed integrally. The preheating part 120 and the atomization part 110 may be connected in two ways: the preheating part 120 and the atomization part 110 are connected into a whole through the electrode contacts 210 or a transition part, and are connected in series or in parallel between the electrodes 200. The invention has no limitation to the structure of the transition part. Preferably, the structure of the transition part is matched and identical with the structure of the atomization part 110 or/and the preheating part 120.

In the structure where the atomization part 110 is attached to the atomization surface of the liquid transfer body, to better fix the atomization part 110, the atomization part 110 is preferably connected to a fixing part configured for fixedly attaching the atomization part 110 to the atomization surface of the liquid transfer body. The specific structure of the fixing part is not limited, and the fixing part may be rod-shaped, strip-shaped, net-like, sheet-like, or the like, the fixing method may be turned with respect to the atomization part 110 to enter liquid, or may be vertically arranged with respect to the atomization part 110, or may have an angle with respect to the atomization part 110; the number of the fixing parts is at least one, and is determined according to the actual positional relationship between the atomization part 110 and the atomization surface of the liquid transfer body, and generally, at least two fixing parts are arranged symmetrically. The invention has no limitation to the position of the fixing parts. The fixing part may be disposed on the edge of the atomization part 110, at the center of the atomization part 110, or at other positions of the atomization part 110. To prevent the edge of the atomization part 110 from warping, the fixing part is preferably arranged at least on the edge of the atomization part 110.

In the structure where the atomization part 110 is attached to the atomization surface of the liquid transfer body and the atomization part 110 is inlaid in the atomization surface of the liquid transfer body, the fixing part may be omitted, the preheating part 120 and the atomization part 110 are connected fixedly or formed integrally, and the preheating part 120 can fix the atomization part 110. In the inlay connection method, the atomization part 110 can be fixed after being inlaid in the atomization surface of the liquid transfer body and can be better fixed through the preheating part 120.

The atomization part 110 and the preheating part 120 may be arranged in two ways: the atomization part 110 and the preheating part 120 are stacked or the atomization part 110 and the preheating part 120 are arranged in a ladder type. Wherein, when the preheating part 120 and the atomization part 110 are stacked, the preheating part 120 and the atomization part 110 may be attached to each other; or, the preheating part 120 may be spaced apart from the atomization part 110, which means that the preheating part 120 is completely spaced apart from the atomization part 110, or one end of the preheating part 120 is fixedly connected to one end of the atomization part 110 or the preheating part 120 is integrated with the atomization part 110, and only the middle portions or/and the other ends of the preheating part 120 and the atomization part 110 are spaced apart from each other.

The atomization part 110 and the preheating part 120 may be stacked in various forms: first, the atomization part 110 and the preheating part 120 are completely stacked, and the projections of the atomization part 110 and the preheating part 120 in a direction perpendicular to the atomization surface overlap entirely; second, the atomization part 110 and the preheating part 120 are partly stacked, and the projections of the atomization part 110 and the preheating part 120 in the direction perpendicular to the atomization surface overlap partially, or the area of the preheating part is smaller than that of the atomization part, so the projections of the atomization part 110 and the preheating part 120 overlap partially. By stacking the atomization part 110 and the preheating part 120, the atomization part 110 can be entirely disposed on the atomization surface, such that e-liquid can be sufficiently atomized, and the volume of a whole atomization device can be reduced without affecting atomization. When the atomization part 110 and the preheating part 120 are arranged in a ladder type, the atomization part 110 only occupies a large part or part of the atomization surface. The atomization part 110 and the preheating part 120 are preferably stacked.

Specifically, in one implementation, the atomization part 110 and the preheating part 120 are each an integral structure, and are stacked or arranged in a ladder type. In another implementation, the atomization part 110 is an integral structure, and the preheating part 120 is formed by multiple separate structures connected to the atomization part 110, and the atomization part 110 and the preheating part 120 are stacked or arranged in a ladder type.

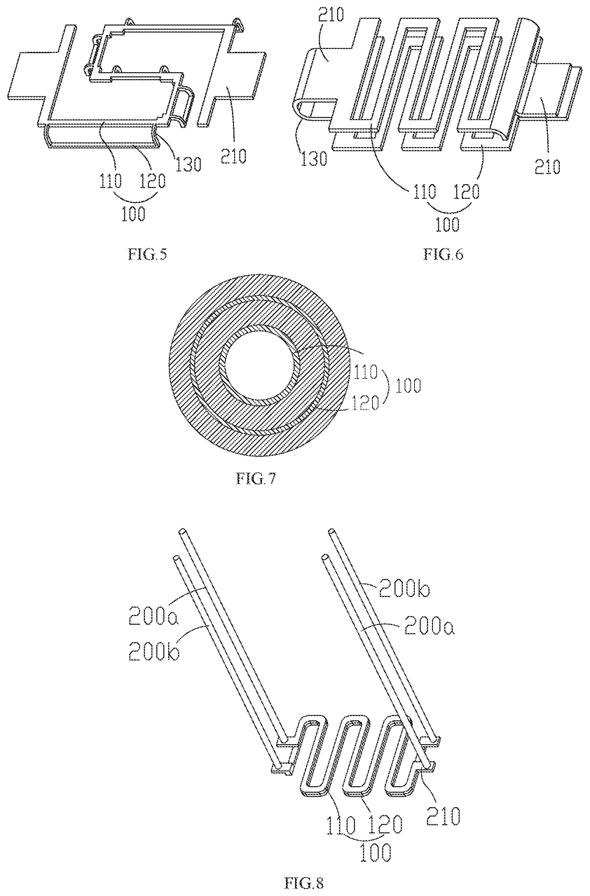

To further describe the invention, several specific embodiments are explained in detail below by way of examples:
Embodiment 1-1: as shown in FIG. 1-FIG. 2, a heating mechanism configured for heating in stages comprises an atomization part 110 configured for evaporating liquid, and common electrodes 200, wherein the atomization part 110 and a preheating part 120 are stacked between the two common electrodes 200, the atomization part 110 and the preheating part 120 are each an integral structure, and the atomization part 110 is matched and identical with an atomization surface of a liquid transfer body in shape and size. The atomization part 110 and the preheating part 120 are parallel to each other, projections of the atomization part 110 and the preheating part 120 overlap entirely, the distance between the atomization part 110 and the preheating part 120 remains unchanged from one end to the other end, and the width of the atomization part 110 remains unchanged. The atomization part 110 is a wavy structure formed by end-to-end connection of multiple curved units and linear units. The atomization part 110 is a planar structure formed in a plane, and turns of the atomization part 110 are arc-shaped, such that an acute angle at the turns is avoided, which may otherwise cause breakage. In this embodiment, the atomization part 110 is attached to the atomization surface of the liquid transfer body, and inverted T-shaped fixing parts 111 are disposed at the arc-shaped turns of the wavy structure of the atomization part 110 and are perpendicular to the plane of the atomization part 110. Fixing parts 211 are also disposed on electrode contacts 210 on the atomization part 110 to reliably fix the electrode contacts 210 on the atomization surface of the liquid transfer body, so as to prevent the electrode contacts 210 from warping or being separated from the atomization surface of the liquid transfer body. Electrode contacts 210 are also disposed at two ends of the preheating part 120, and when the preheating part 120 and the atomization part 110 are assembled together, the electrode contacts 210 of the preheating part 120 are fixedly connected to the corresponding electrode contacts 210 of the atomization part 110 respectively, such that the preheating part 120 and the atomization part 110 are fixedly connected, and every two corresponding electrode contacts 210 are connected to one electrode 200.
Embodiment 1-2: as shown in FIG. 3, this embodiment provides a heating mechanism configured for heating in stages, which is improved based on Embodiment 1-1. The heating mechanism in this embodiment is improved specifically in the following aspects: no fixing part is disposed on the atomization part 110, the atomization part 110 and the preheating part 120 are an integrated structure, one end of the atomization part 110 and one end of the preheating part 120 are joined together to form one electrode contact 210, the other end of the atomization part 110 and the other end of the preheating part 120 are joined together to form the other electrode contact 210, and the atomization part 110 and the preheating part 120 are connected into an integral structure through the electrode contacts 210. This embodiment is identical with Embodiment 1-1 in other structures, and will not be detailed here.
Embodiment 1-3: as shown in FIG. 4, this embodiment provides a heating mechanism configured for heating in stages, which is improved based on Embodiment 1-2. The heating mechanism in this embodiment is improved specifically in the following aspects: electrode contacts 210 are turned to be parallel with the atomization surface, such that the contact area is enlarged; three electrode contacts 210 are used, wherein one end of the preheating part 120 and one end of the atomization part 110 are joined together and share one electrode contact 210, which is connected to a common electrode, and the other two electrode contacts 210 are respectively disposed at the other end of the preheating part 120 and the other end of the atomization part 110, which are connected to an atomization electrode and a preheating electrode separately. The preheating part 120 and the atomization part 110 are connected into an integral structure through the electrode contacts 210. This embodiment is identical with Embodiment 1-2 in other structures, and will not be detailed here.
Embodiment 1-4: as shown in FIG. 5, this embodiment provides a heating mechanism configured for heating in stages, which is improved based on Embodiment 1-2. The heating mechanism in this embodiment is improved specifically in the following aspects: the atomization part 110 is a zigzag structure formed by a linear unit, and the width of turns of the atomization part 110 is greater than that of other positions of the atomization part 110, such that the overall structural strength is improved. The atomization part 110 is connected between two electrode contacts 210, and the two electrode contacts 210 are each connected to a common electrode. The atomization part 110 and the preheating part 120 are connected in parallel partially, that is, two ends of the atomization part 110 are connected to the electrode contacts 210 respectively, and the preheating part 120 is connected in parallel with one section of the atomization part 110. In this embodiment, multiple preheating parts 120 are used, and they are connected in parallel with different positions of the atomization part 110 respectively, and are fixed on the atomization part 110 through transition parts 130. This embodiment is identical with Embodiment 1-2 in other structures, and will not be detailed here.
Embodiment 1-5: as shown in FIG. 6, this embodiment provides a heating mechanism configured for heating in stages, which is improved based on Embodiment 1-2. The heating mechanism in this embodiment is improved specifically in the following aspects: the atomization part 110 and the preheating part 120 are formed integrally and are connected through a transition part 130; when manufactured, the planar atomization part 110, the transition part 130, the preheating part 120 and electrode contacts 210 at two ends are made first, then the transition part 130 is bent to enable the atomization part 110 and the preheating part 120 to be stacked, the electrode contacts 210 at each end are attached and fixed together to form one electrode contact 210, and the transition part 130 can be used as another electrode contact 210. This embodiment is identical with Embodiment 1-2 in other structures, and will not be detailed here. In this structure, the common electrodes may be only connected to the electrode contacts 210 at the two ends, and the transition part 130 is merely configured for transitional connection, such that the atomization part 110 and the preheating part 120 are connected in series. The current in the circuit formed by series connection of the atomization part 110 and the preheating part 120 is constant, so desired temperature can be adjusted by designing different sectional areas of conductors of the preheating part 120 and the atomization part 110.
Embodiment 1-6: as shown in FIG. 7, this embodiment provides a heating mechanism configured for heating in stages, which is improved based on Embodiment 1-2. The heating mechanism in this embodiment is improved specifically in the structure of the atomization part 110 and the preheating part 120, that is, the atomization part 110 and the preheating part 120 are both curved units and are specifically cylindrical structures, wherein the atomization part 110 is a small-diameter cylindrical structure and is attached to an inner wall of the liquid transfer body of a cylindrical structure, and the preheating part 120 is a large-diameter cylindrical structure and is buried in the liquid transfer body of the cylindrical structure. Electrode contacts 210 (not shown) are disposed at the ends of the cylindrical structures. This embodiment is identical with Embodiment 1-2 in other structures, and will not be detailed here. In this structure, the atomization part 110 may be inlaid in the inner wall of the liquid transfer body of the cylindrical structure.
Embodiment 1-7: as shown in FIG. 8, this embodiment provides a heating mechanism configured for heating in stages, which is improved based on Embodiment 1-1. The heating mechanism in this embodiment is improved specifically in the following aspects: four electrodes, namely two atomization electrodes 200a and two preheating electrodes 200b, are used, the atomization part 110 is connected between the two atomization electrodes 200a, and the preheating part 120 is connected between the two preheating electrodes 200b. In addition, the atomization part 110 and the preheating part 120 are attached together, with no space or a small space being reserved therebetween. This embodiment is identical with Embodiment 1-1 in other structures, and will not be detailed here.

On the basis of the above embodiments, the arrangement of the atomization part 110 may form into other various structures. For example, the atomization part 110 may be a zigzag line formed by the combination of linear unit or an arc line formed by curved units, such that more turns are formed, the contact area between the atomization part 110 and the heating unit is larger, and the resistance of the circuit can be higher.

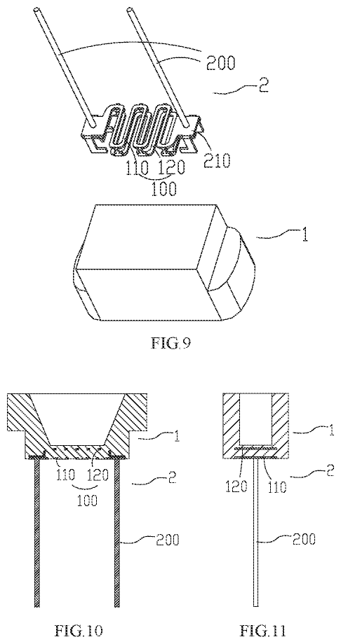

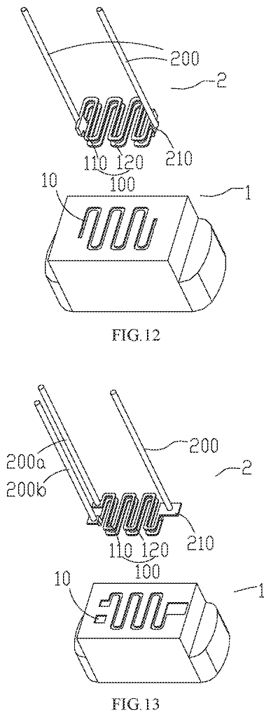

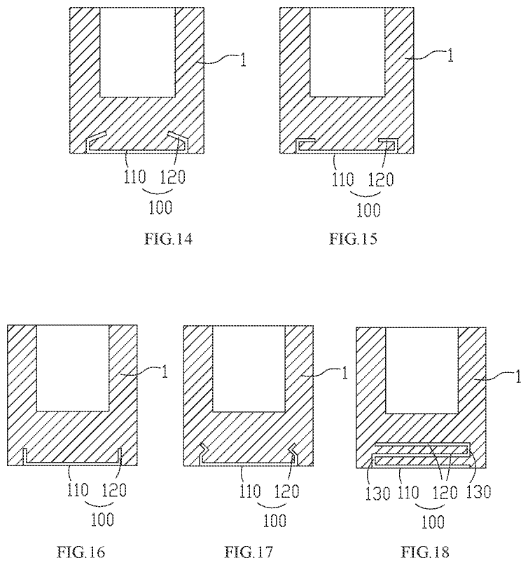

As shown in FIG. 9-FIG. 18, an atomization device comprises a liquid transfer body 1, and the heating mechanism 2 in Embodiment 1, wherein the atomization part 110 of the heating mechanism 2 is inlaid in or attached to an atomization surface of the liquid transfer body 1. The preheating part 120 is buried in the liquid transfer body 1. In this embodiment, the liquid transfer body 1 is a ceramic porous body, the heating mechanism 2 is located at the bottom of the ceramic porous body and is flatly attached to the bottom of the porous ceramic body. A detailed description will be given below with reference to specific embodiments.
Embodiment 2-1: as shown in FIG. 9-FIG. 11, an atomization device comprises a liquid transfer body 1, and the heating mechanism 2 in Embodiment 1-1, wherein the liquid transfer body 1 is a square trough structure, and the atomization part 110 of the heating mechanism 2 is attached to the bottom of the liquid transfer body 1. The preheating part 120 is buried in the liquid transfer body 1. The specific structure of the heating mechanism 2 is the same as that of Embodiment 1, and will not be detailed here.
Embodiment 2-2: as shown in FIG. 12, an atomization device comprises a liquid transfer body 1, and the heating mechanism 2 in Embodiment 1-2, wherein the liquid transfer body 1 is a square trough structure, and an inlay socket 10 is formed in the bottom of the liquid transfer body 1, and the atomization part 110 of the heating mechanism 2 is inlaid in the inlay socket in the bottom of the liquid transfer body 1. The preheating part 120 is buried in the liquid transfer body 1.
Embodiment 2-3: as shown in FIG. 13, this embodiment is improved based on Embodiment 2-2, the heating mechanism in Embodiment 1-3 is used, one end of the preheating part 120 and one end of the atomization part 110 are joined together and share one electrode contact 210, which is connected to a common electrode 200, and the other two electrode contacts 210 are respectively disposed at the other end of the preheating part 120 and the other end of the atomization part 110, which are connected to an atomization electrode 200a and a preheating electrode 200b separately. The preheating part 120 and the atomization part 110 are connected into an integral structure through the electrode contact 210 connected to the common electrode 200. In this embodiment, the heating circuit comprising the atomization part 110 and the preheating part 120 of the heating mechanism can be formed by bending a planar heating circuit, and the common electrode 200 and two separate electrodes (the atomization electrode 200a and the preheating electrode 200b) form three electrode contacts 210 on a ceramic surface (by means of contact of contact electrodes or welding leads of electrodes), which can be connected in series or in parallel during use, or be separately configured for power supply.

During use, in the initial state where e-liquid is at normal temperature and the preheating part 120 needs to work, the preheating part 120 and the atomization part 110 work at the same time; when the atomization device is continuously used by users for a period of time, the e-liquid is preheated, the viscosity of the e-liquid is low, and at this moment, the preheating part 120 is not needed for heating anymore, so the circuit of the preheating part 120 is cut off which can be realized via designing a circuit scheme of a battery, and the atomization part 110 works alone.
Embodiment 2-4: as shown in FIG. 14-FIG. 18, this embodiment is improved based on Embodiment 2-1 in the structure of the preheating part 120 and the connection and positional relation between the preheating part 120 and the atomization part 110. In this embodiment, the preheating part 120 and the atomization part 110 are locally connected in parallel or in series, wherein as shown in FIG. 14-FIG. 17, the preheating part 120 and the atomization part 110 are locally connected in parallel, and as shown in FIG. 18, the preheating part 120 and the atomization part 110 are locally connected in series. Two layers of preheating parts 120 are arranged and are both parallel with the atomization part 110, and at the bent portions are connected through transition parts.

The specific structure of the heating mechanism 2 is the same as that of Embodiment 1, and will not be detailed here.

1. A heating mechanism configured for heating in stages, comprising a heating circuit configured for evaporating liquid, and electrodes configured to be connected to a power supply unit, wherein the heating circuit comprises a preheating part buried in a liquid transfer body, and an atomization part attached to or inlaid in an atomization surface of the liquid transfer body;
the preheating part and the atomization part are connected in series and/or in parallel between the electrodes;
the preheating part and the atomization part are stacked, such that projections of the preheating part and the atomization part overlap entirely or partially; or, the preheating part and the atomization part are arranged in a ladder type, such that the projections of the preheating part and the atomization part do not overlap;
at least the atomization part is an integral structure, and is matched and identical with the atomization surface of the liquid transfer body in shape and size.

2. The heating mechanism configured for heating in stages according to claim 1, wherein the electrodes comprise a preheating electrode, an atomization electrode and a common electrode, the atomization part is connected between the atomization electrode and the common electrode through electrode contacts, and the preheating part is connected between the preheating electrode and the common electrode through electrode contacts.

3. The heating mechanism configured for heating in stages according to claim 1, wherein the electrodes comprise two preheating electrodes and two atomization electrodes, the atomization part is connected between the two atomization electrodes through electrode contacts, and the preheating part is connected between the two preheating electrodes through electrode contacts.

4. The heating mechanism configured for heating in stages according to claim 1, wherein the electrodes comprise two common electrodes, and the atomization part and the preheating part are connected in series and/or in parallel between the two common electrodes through electrode contacts.

5. The heating mechanism configured for heating in stages according to claim 1, wherein the preheating part and the atomization part are formed integrally to form an integral structure.

6. The heating mechanism configured for heating in stages according to claim 1, wherein the atomization part and the preheating part are each an integral structure, and the atomization part and the preheating part are stacked or arranged in a ladder type.

7. The heating mechanism configured for heating in stages according to claim 1, wherein the atomization part is an integral structure, and the preheating part is formed by multiple separate structures connected to the atomization part, and the atomization part and the preheating part are stacked or arranged in a ladder type.

8. The heating mechanism configured for heating in stages according to claim 1, wherein the preheating part and the atomization part are each a planar structure, a curved structure, or a combination of at least one of the planar structure and the curved structure.

9. The heating mechanism configured for heating in stages according to claim 8, wherein the preheating part and the atomization part are each a planar structure or a combination of said planar structures, and are arranged in parallel; or, the preheating part and the atomization part are each a planar structure or a combination of said planar structures, an angle α is formed between the preheating part and the atomization part, and 90°≥α>0°.

10. The heating mechanism configured for heating in stages according to claim 8, wherein the atomization part is a planar structure or a combination of said planar structures, and the preheating part is a curved structure or a combination of said curved structures.

11. The heating mechanism configured for heating in stages according to claim 8, wherein the atomization part is a curved structure and a combination of said curved structures, and the preheating part is one of a curved structure, a combination of said curved structures, a planar structure or a combination of said planar structures.

12. The heating mechanism configured for heating in stages according to claim 2, wherein the preheating part and the atomization part are connected into an integral structure through electrode contacts or through a transition part.

13. The heating mechanism configured for heating in stages according to claim 1, wherein a diameter or width of the atomization part is constant or basically constant; or, the diameter or width of the atomization part increases or decreases gradually or is regular with respect to a center of the heating mechanism.

14. The heating mechanism configured for heating in stages according to claim 1, wherein a distance between different positions of the atomization part is constant from one end to the other end, or decreases gradually from a middle to two ends of the atomization part, or increases gradually form the middle to the two ends of the atomization part.

15. The heating mechanism configured for heating in stages according to claim 1, wherein the atomization part is connected to a fixing part configured for fixedly attaching the atomization part to the atomization surface of the liquid transfer body.

16. The heating mechanism configured for heating in stages according to claim 15, wherein at least one said fixing part is arranged and is disposed at least on an edge of the atomization part.

17. An atomization device, comprising a liquid transfer body, and the heating mechanism according to claim 1, wherein the heating mechanism is inlaid in or attached to a surface of the liquid transfer body.

18. An atomization device, comprising a liquid transfer body, and the heating mechanism according to claim 2, wherein the heating mechanism is inlaid in or attached to a surface of the liquid transfer body.

19. The heating mechanism configured for heating in stages according to claim 3, wherein the preheating part and the atomization part are connected into an integral structure through electrode contacts or through a transition part.

20. The heating mechanism configured for heating in stages according to claim 4, wherein the preheating part and the atomization part are connected into an integral structure through electrode contacts or through a transition part.
